(19) United States
(12) Patent Application Publication
(10) Pub. No.: US 2025/0183249 A1
(43) Pub. Date: Jun. 5, 2025

(54) MANUFACTURING METHOD OF BIPOLAR ELECTRODE, AND BIPOLAR ELECTRODE

(71) Applicant: TOYOTA JIDOSHA KABUSHIKI KAISHA, Toyota-shi (JP)

(72) Inventors: Takahiko NAKANO, Nagoya-shi (JP); Yusuke KINTSU, Miyoshi-shi (JP)

(73) Assignee: TOYOTA JIDOSHA KABUSHIKI KAISHA, Toyota-shi (JP)

(21) Appl. No.: 18/824,091

(22) Filed: Sep. 4, 2024

(30) Foreign Application Priority Data
Dec. 5, 2023 (JP) 2023-205292

(51) Int. Cl. H01M 4/04; H01M 4/02; H01M 4/583

(52) U.S. Cl. CPC H01M 4/0404; H01M 4/583; H01M 2004/029

(57) ABSTRACT

A manufacturing method of a bipolar electrode includes the following (a) to (f). (a) A first carbon film is formed on the sheet-shaped support material. (b) A conductive resin layer is formed on the first carbon film. (c) A second carbon film is formed on the conductive resin layer. (d) A second electrode layer is formed on the second carbon film. (e) The support is separated from the first carbon coating. (f) A bipolar electrode is manufactured by forming a first electrode layer on the first carbon film.

### CROSS-REFERENCE TO RELATED APPLICATION

This application claims priority to Japanese Patent Application No. 2023-205292 filed on Dec. 5, 2023, incorporated herein by reference in its entirety.

### BACKGROUND

### 1. Technical Field

The present disclosure relates to a manufacturing method of a bipolar electrode, and to the bipolar electrode.

### 2. Description of Related Art

Japanese Unexamined Patent Application Publication No. 2023-053669 (JP 2023-053669 A) discloses a bipolar electrode.

### SUMMARY

Conventionally, a current collector of a bipolar electrode is manufactured by laminating two kinds of metal foils. From a perspective of effective utilization of resources, for example, reducing an amount of metal used is desirable.

An object of the present disclosure is to reduce the amount of metal used.

1. A manufacturing method of a bipolar electrode includes the following (a) to (f).
(a) A first carbon film is provided on a support material that is in a sheet form.
(b) A conductive resin layer is provided on the first carbon film.
(c) A second carbon film is provided on the conductive resin layer.
(d) A second electrode layer is provided on the second carbon film.
(e) The support material is separated from the first carbon film.
(f) The bipolar electrode is manufactured by providing a first electrode layer on the first carbon film. The above (d), (e) and (f) are performed in an order of the (d), the (e) and the (f).

The use of a conductive resin layer as a current collector in place of the metal foil greatly reduces the amount of metal used. However, in general, the conductive resin layer does not readily serve as a self-supporting layer, and accordingly providing an electrode layer on the conductive resin layer is difficult. Hence, the support material is used. The conductive resin layer is formed on the support material. By providing one electrode layer on one side of the conductive resin layer, the conductive resin layer and the electrode layer can provide the self-supporting layer, as a whole. After formation of the self-supporting layer, the support material is separated. After separation of the support material, the other electrode layer is formed on a rear face of the conductive resin layer. The conductive resin layer can exhibit sufficient electron conductivity in a thickness direction. However, the conductive resin layer tends to have poor electron conductivity in a plane direction. Accordingly, forming carbon film on both faces of the conductive resin layer can be expected to improve in the electron conductivity in the plane direction.

2. The manufacturing method according to the above “1” may include, for example, the following configuration. The support material includes a fluororesin.

Fluororesin tends to have excellent releasability (non-stickiness). By the support material containing a fluororesin, separation of the support material is expected to be facilitated.

3. The manufacturing method according to the above “1” or “2” may include, for example, the following configuration. The first electrode layer is a cathode layer. The second electrode layer is an anode layer.

In general, the anode layer has a larger area than the cathode layer. By forming the anode layer first, for example, when forming the cathode layer, improvement in handling properties is expected.

4. A bipolar electrode includes, in the thickness direction, a cathode layer, a first carbon film, a conductive resin layer, a second carbon film, and an anode layer, in an order of the cathode layer, the first carbon film, the conductive resin layer, the second carbon film, and the anode layer.

5. The bipolar electrode according to the above “4” may include, for example, the following configuration. Area of the conductive resin layer is larger than each of the first electrode layer, the first carbon film, the second carbon film, and the second electrode layer. The conductive resin layer extends so as to cover side faces of the first carbon film.

Due to the conductive resin layer having a greatest area, the conductive resin layer can be in direct contact with sealing material in the bipolar battery. For example, as compared with when the carbon film is interposed between the conductive resin layer and the sealing material, the conductive resin layer is in direct contact with the sealing material, and accordingly sealing properties are expected to be improved.

Hereinafter, an embodiment of the present disclosure (which may hereinafter be abbreviated as “present embodiment”) and an example of the present disclosure (which may hereinafter be abbreviated as “present example”) will be described. However, the present embodiment and the present example do not limit the technical scope of the present disclosure. The present embodiment and the present example are exemplary in all respects. The present embodiment and the present example are not restrictive. The technical scope of the present disclosure includes all changes that fall within the meaning and scope equivalent to the claims. For example, it is originally planned to extract appropriate configurations from the present embodiment and combine such configurations as appropriate.

Geometric terms (e.g., parallel, vertical, orthogonal, etc.) should not be interpreted in a strict sense. For example, “parallel” may deviate somewhat from “parallel” in a strict sense. The geometric terms may include, for example, design-related, work-related, or manufacturing-related, tolerances, variations, and so forth. Dimensional relationships in each drawing may not match actual dimensional relationships. The dimensional relationships in the drawings may be changed to facilitate understanding by readers. For example, the length, width, thickness, and so forth, may be changed. Some configurations may be omitted.

Numerical ranges such as “m to n %” include upper and lower limits unless otherwise specified. “m to n %” indicates a numerical range of “m % or more and n % or less”. “m % or more and n % or less” includes “more than m % and less than n %”.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic flowchart of a manufacturing method of a bipolar electrode according to the present embodiment;

FIG. 2 is a first schematic cross-sectional view showing a manufacturing process of a bipolar electrode;

FIG. 3 is a second schematic cross-sectional view showing a manufacturing process of a bipolar electrode;

FIG. 4 is a third schematic cross-sectional view showing a manufacturing process of a bipolar electrode;

FIG. 5 is a fourth schematic cross-sectional view showing a manufacturing process of a bipolar electrode;

FIG. 6 is a fifth schematic cross-sectional view showing a manufacturing process of a bipolar electrode;

FIG. 7 is a sixth schematic cross-sectional view showing a manufacturing process of a bipolar electrode;

FIG. 8 is a first schematic cross-sectional view showing an example of a bipolar electrode according to the present embodiment;

FIG. 9 is a second schematic cross-sectional view showing an example of a bipolar electrode according to the present embodiment;

FIG. 10 is a schematic cross-sectional view showing an exemplary bipolar battery according to the present embodiment; and

FIG. 11 is a table showing evaluation results.

### DETAILED DESCRIPTION OF EMBODIMENTS

### Bipolar Electrode Manufacturing Method

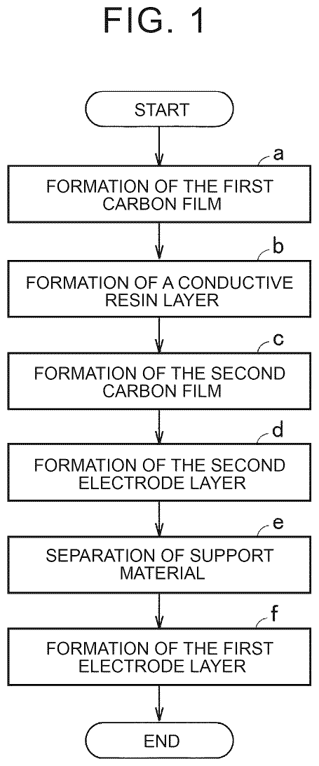

FIG. 1 is a schematic flowchart of a manufacturing method of a bipolar electrode according to the present embodiment. Hereinafter, the “manufacturing method of a bipolar electrode according to the present embodiment” may be abbreviated as “the present manufacturing method”. The manufacturing method includes “(a) formation of a first carbon film”, “(b) formation of a conductive resin layer”, “(c) formation of a second carbon film”, “(d) formation of a second electrode layer”, “(e) separation of a support material”, and “(f) formation of a first electrode layer”. (d) to (f) are performed in this order. The steps may be performed, for example, by a roll to roll method. Unless otherwise noted, the order of each step is arbitrary. For example, three of (a), (b) and (c) may be performed simultaneously.

In the present manufacturing method, the terms “first” and “second” are simply used to distinguish between two elements. The terms “first” and “second” do not include, for example, concepts such as order. For example, “on the support material” refers to “on the surface of the support material”. The term “up” is independent of up and down in the vertical direction.

### (a) Formation of the First Carbon Film

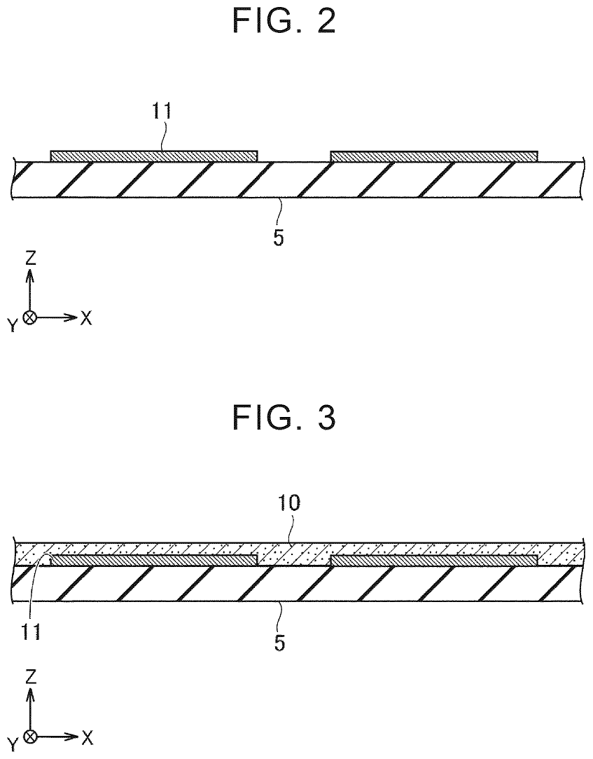

FIG. 2 is a first schematic cross-sectional view showing a manufacturing process of a bipolar electrode. The manufacturing method includes forming the first carbon film 11 on the sheet-shaped support material 5.

The support material 5 has any thickness. The thickness of the support material 5 may be, for example, 0.1 to 2 mm. The support material 5 may have releasability. The support material may include, for example, a fluororesin. The support material 5 may include, for example, at least one selected from the group consisting of polytetrafluoroethylene (PTFE), tetrafluoroethylene-perfluoroalkyl vinyl ether copolymer (PFA), polyvinylidene difluoride (PVDF), tetrafluoroethylene-hexafluoropropylene copolymer (FEP), tetrafluoroethylene-ethylene copolymer (ETFE), polychlorotrifluoroethylene (PCTFE), and chlorotrifluoroethylene-ethylene copolymer (ECTFE).

The entire support material 5 may have a releasing property, or a part thereof may have a releasing property. For example, the release property may be imparted to the surface of a substrate by applying a component having a release property to the surface of an arbitrary substrate. The component having releasability may include, for example, silicone.

For example, the first carbon film 11 may be formed on the surface of the support material 5 by coating the first dispersion liquid. The first dispersion may include, for example, a first carbon material, a binder, and a dispersion medium. The coating method is optional. For example, a gravure coater, a die coater, or the like may be used. The coating film may be formed continuously or intermittently. In FIG. 2, as an example, a coating film is intermittently formed. For example, the coating may be dried in a drying oven. The same applies to the subsequent method of forming the second carbon film 12 and the various layers (coating method, drying method).

The thickness of the first carbon film 11 may be, for example, 0.1 to 3 μm. For example, the first carbon film 11 may include 50% or more of the first carbon material and the remaining binder in a mass fraction. The mass fraction of the first carbon material may be, for example, from 75 to 99%, or from 80 to 95%. The first carbon material has electronic conductivity. The first carbon material may include, for example, at least one selected from the group consisting of acetylene black (AB), graphite, vapor-grown carbon fibers (VGCF), graphene flakes (GF), carbon nanotubes (CNT), carbon nanofibers (CNF), and carbon nanospheres (CNS). The binder may include, for example, at least one selected from the group consisting of PVDF, PTFE, carboxymethylcellulose (CMC), and polyacrylic acid (PAA).

### (b) Formation of a Conductive Resin Layer

FIG. 3 is a second schematic cross-sectional view showing a manufacturing process of a bipolar electrode. The manufacturing method includes forming a conductive resin layer 10 on the first carbon film 11. For example, the conductive resin layer 10 may be formed by applying a conductive adhesive to the surface of the first carbon film 11. The conductive resin layer 10 may be applied continuously, for example. The conductive adhesive may be of one-liquid type or of two-liquid type. The conductive adhesive may include, for example, a main agent, a curing agent, and a conductive filler. The main agent may contain, for example, an olefin resin or the like. The curing agent may include, for example, a compound having an isocyanate group.

The thickness of the conductive resin layer 10 may be, for example, 1 to 100 μm, 1 to 50 μm, 1 to 30 μm, 1 to 10 μm, or 1 to 5 μm. The conductive resin layer 10 has electronic conductivity. The conductive resin layer 10 may include, for example, a resin material and a conductive filler. For example, the conductive resin layer 10 may include 1 to 99% by mass of the conductive filler and the remainder of the resin material. The mass fraction of the conductive filler may be, for example, 5 to 50%, or 10 to 30%.

In the conductive resin layer 10, the resin material forms a continuous phase. The resin material may have resistance to an electrolytic solution. The resin material may be insoluble in the electrolytic solution. The resin material may include, for example, at least one selected from the group consisting of olefin-based resin, urethane-based resin, polyamide-based resin, cellulosic resin, polyether-based resin, acrylic resin, epoxy-based resin, and polyester-based resin. The resin material may have, for example, a hydroxyl group. When the resin material has a hydroxyl group, a hydrogen bond can be formed with the sealing member 40 described later. The formation of hydrogen bonds is expected to improve sealing properties.

In the conductive resin layer 10, the conductive filler forms a dispersed phase. The conductive filler is a conductive component. The conductive filler may include, for example, carbon particles, metal particles, metal plated particles, and the like. The core of the metal plated particles may be solid or hollow resin particles. The conductive filler may include, for example, at least one selected from the group consisting of AB, graphite, VGCF, CNT, CNF, CNS, Ni particles, Ni plated particles, Cu particles, and Cu plated particles. The particle shape of the conductive filler is arbitrary. The conductive filler may be, for example, spherical, flake-like, rod-like, needle-like, fiber-like, or the like. The particle size of the conductive filler may be, for example, 0.1 to 10 μm, 0.5 to 5 μm, or 1 to 3 μm. “Particle size” refers to the average value of the maximum ferret size in a particle image. The average value is calculated from 10 or more measurement results.

### (c) Formation of the Second Carbon Film

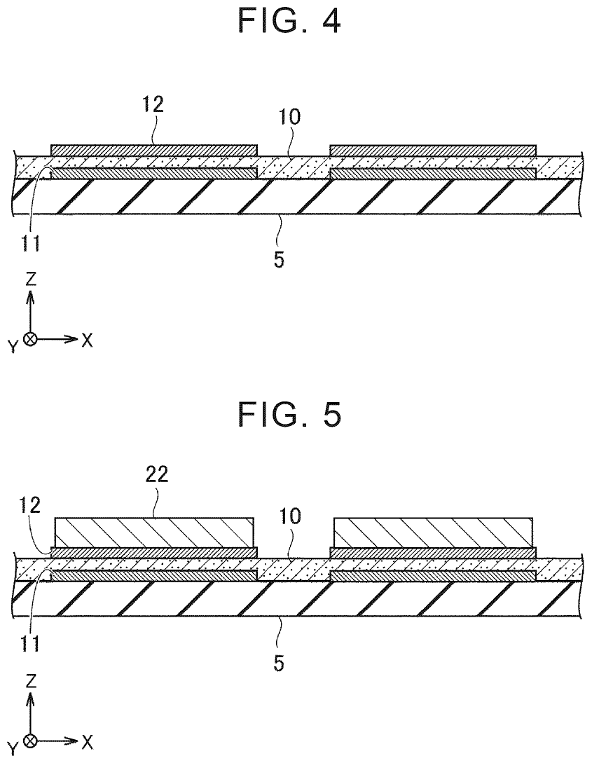

FIG. 4 is a third schematic cross-sectional view showing a manufacturing process of the bipolar electrode. The manufacturing method includes forming a second carbon film 12 on the conductive resin layer 10. The second carbon film 12 may be formed in the same manner as the first carbon film 11. Compositions and dimensions of the second carbon film 12 and the first carbon film 11 may be the same or different from each other. The composition and dimensions of the second carbon film 12 may be selected and adjusted, for example, within the scope of the description described above as the composition and dimensions of the first carbon film 11.

### (d) Formation of the Second Electrode Layer

FIG. 5 is a fourth schematic cross-sectional view showing a manufacturing process of the bipolar electrode. The manufacturing method includes forming a second electrode layer 22 on the second carbon film 12. For example, the second electrode layer 22 may be formed by coating the second electrode mixture paste on the surface of the second carbon film 12. The second electrode mixture paste may include, for example, a second electrode mixture and a dispersion medium. After the formation of the second electrode layer 22 (after drying of the second electrode mixture paste), the entire workpiece may be compressed. Compression of the workpiece may be performed after formation of the first electrode layer 21 described later.

### (e) Separation of the Support Material

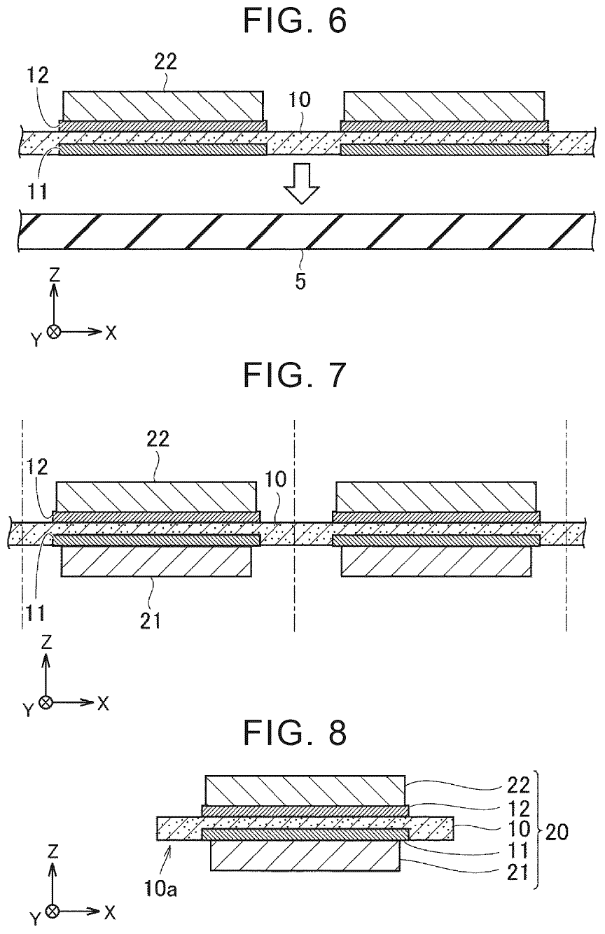

FIG. 6 is a fifth schematic cross-sectional view showing a manufacturing process of the bipolar electrode. The manufacturing method includes separating the support material 5 from the first carbon film 11. The support material 5 may be peeled off by an external force, for example. For example, a jig such as a scraper may be used to form the break-off. It is expected that peeling of the support material 5 is promoted by the support material 5 having the releasability. The collected support material 5 can be reused.

### (f) Formation of the First Electrode Layer

FIG. 7 is a sixth schematic cross-sectional view showing a manufacturing process of the bipolar electrode. The manufacturing method includes manufacturing the bipolar electrode 20 by forming the first electrode layer 21 on the first carbon film 11. For example, the first electrode layer 21 may be formed by coating the first electrode mixture paste on the surface of the first carbon film 11. The first electrode mixture paste may include, for example, a first electrode mixture and a dispersion medium.

The first electrode layer 21 may have a smaller area than the second electrode layer 22. The first electrode layer 21 has a polarity different from that of the second electrode layer 22. For example, the first electrode layer 21 may be a cathode layer, and the second electrode layer 22 may be an anode layer. For example, the first electrode layer 21 may be an anode layer, and the second electrode layer 22 may be a cathode layer. The cathode layer includes a positive electrode active material. The positive electrode active material may include, for example, a lithium nickel composite oxide, lithium iron phosphate, and the like. The anode layer includes a negative electrode active material. The negative electrode active material may include, for example, graphite, silicon oxide, silicon, and the like. Each of the cathode layer and the anode layer may further include a conductive material and a binder. Each of the cathode layer and the anode layer may independently include AB, PVDF, CMC, SBR or the like.

After the formation of the first electrode layer 21, the bipolar electrode 20 may be compressed. After compression, the thicknesses of the first electrode layer 21 and the second electrode layer 22 may be, for example, 10 to 500 μm, 50 to 300 μm, or 100 to 200 μm, respectively. The bipolar electrode 20 (original sheet) may be cut according to battery specifications. The dashed-dotted line in FIG. 7 is an example of a cutting line.

### Bipolar Electrode

FIG. 8 is a first schematic cross-sectional view illustrating an example of a bipolar electrode according to the present embodiment. The bipolar electrode 20 has a thickness direction (Z direction). The bipolar electrode 20 includes the first electrode layer 21, the first carbon film 11, the conductive resin layer 10, the second carbon film 12, and the second electrode layer 22 in this order in the thickness direction. The conductive resin layer 10 functions as an electrode current collector. The conductive resin layer 10 may have a larger area than each of the first electrode layer 21, the first carbon film 11, the second carbon film 12, and the second electrode layer 22. The conductive resin layer 10 may have an area of, for example, 1.01 to 1.5 times, 1.05 to 1.25 times, or 1.1 to 1.2 times as large as that of each of the other components (such as the first electrode layer 21).

The conductive resin layer 10 may extend so as to cover the side surface of the first carbon film 11. In XY plane, the conductive resin layer 10 may include the respective films and a peripheral edge portion 10a extending outward of the respective layers. The peripheral edge portion 10a may be flush with the first carbon film 11. For example, the bipolar electrode 20 of FIG. 8 can be formed by forming the first carbon film 11 or the like by intermittent coating.

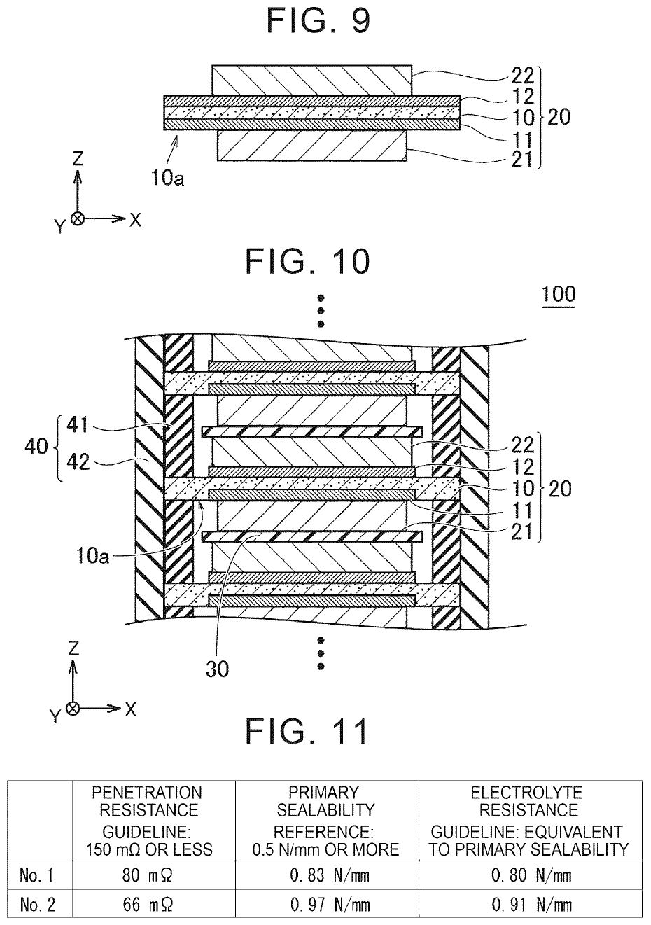

FIG. 9 is a second schematic cross-sectional view illustrating an example of a bipolar electrode according to the present embodiment. For example, each of the first carbon film 11 and the second carbon film 12 may extend so as to cover the peripheral edge portion 10a of the conductive resin layer 10. For example, the bipolar electrode 20 of FIG. 9 may be formed by forming the first carbon film 11 and the second carbon film 12 by continuous coating.

In the bipolar electrode 20, a resistance when electrons flow in the thickness direction in components other than the first electrode layer 21 and the second electrode layer 22 may also be referred to as a “penetration resistance”. For example, in FIG. 9, the penetration resistance is a resistance between the first carbon film 11 and the second carbon film 12. The penetration resistance may be, for example, 150 mΩ or less. The penetration resistance may be, for example, 100 mΩ or less, or 80 mΩ or less. The penetration resistance may be, for example, 10 mΩ or more, or 50 mΩ or more.

### Bipolar Battery

FIG. 10 is a schematic cross-sectional view illustrating an example of a bipolar battery according to the present embodiment. The bipolar battery 100 includes a plurality of bipolar electrodes 20, an electrolytic solution (not shown), and a sealing member 40. The bipolar battery 100 may include, for example, an exterior body (not shown). The exterior body may contain the bipolar electrode 20 and the electrolytic solution. The exterior body may be, for example, a pouch made of a metal foil laminate film, a case made of metal, or the like.

The electrolyte is a liquid electrolyte. The electrolyte may include, for example, a support salt and a solvent. The support salt may include, for example, LiPF₆. The solvent may include, for example, ethylene carbonate, ethyl methyl carbonate, dimethyl carbonate, diethyl carbonate, and the like. The electrolyte solution may further contain an optional additive.

The plurality of bipolar electrodes 20 are stacked in the thickness direction (Z direction). The bipolar battery 100 may further include a separator 30. The separator 30 is disposed between the first electrode layer 21 and the second electrode layer 22. The separator 30 separates the first electrode layer 21 from the second electrode layer 22. The separator 30 may include, for example, a porous film made of resin.

On the peripheral edge portion 10a of the bipolar electrode 20, the sealing member 40 seals between two neighboring conductive resin layer 10. The conductive resin layer 10 may be in direct contact with the sealing member 40. For example, by using the bipolar electrode 20 of FIG. 8, the conductive resin layer 10 may be in direct contact with the sealing member 40. When the conductive resin layer 10 is in direct contact with the sealing member 40, for example, the sealing property is expected to be improved.

In XY plane, the sealing member 40 surrounds the first electrode layer 21 and the second electrode layer 22. The sealing member 40 may include, for example, a first sealing member 41 (primary sealing) and a second sealing member 42 (secondary sealing). The first sealing member 41 may seal between adjacent conductive resin layers 10. The second sealing member 42 may further seal the outside of the first sealing member 41. The sealing member 40 includes, for example, a resin material. The sealing material may include, for example, at least one selected from the group consisting of polypropylene, polyphenylene sulfide, and modified polyphenylene ether. The second sealing member 42 may be the same material as the first sealing member 41, or may be a different material.

The “primary sealing property” indicates the peel strength between the first sealing member 41 and the conductive resin layer 10 (or the carbon film). Peel strength can be measured by the 90 degree Peel Test (ISO 29862:2007). The primary sealing property of the bipolar battery 100 may be, for example, 0.5 N/mm or more. The primary sealing property may be, for example, 0.8 N/mm or higher, or 1.0 N/mm or higher.

“Electrolyte resistance” refers to the primary sealability after being immersed in an electrolytic solution for 1000 hours. The electrolyte resistance of the bipolar battery 100 may be, for example, 0.5 N/mm or more. The electrolyte resistance may be, for example, 0.8 N/mm or higher, or 1.0 N/mm or higher.

### Preparation of Samples

### No. 1

A support material (PTFE seat) was placed on the web handling conveyor. The first dispersion was continuously coated on the surface of the support material and dried to form a first carbon film. A conductive adhesive was prepared by mixing a main agent (olefin-based resin), a curing agent (isocyanate compound), and conductive fillers (Ni plated particles). A conductive adhesive was continuously applied to the surface of the first carbon film and dried to form a conductive resin layer. The second dispersion liquid was continuously coated on the surface of the conductive resin layer and dried to form a second carbon film. The second carbon film had substantially the same composition and the same size as the first carbon film. A negative electrode mixture paste was continuously coated on the surface of the second carbon film and dried to form an anode layer. After the formation of the anode layer, the support material was peeled from the workpiece and wound up. After the support material was peeled off, a positive electrode mixture paste was continuously coated on the surface of the first carbon film and dried to form a cathode layer. Thus, a bipolar electrode was manufactured. Note that various coating films and coating layers were dried in a drying furnace. The drying conditions were all as follows.
Line-speed: 15 m/min
Drying furnace temperature: 150° C.

### No. 2

Adhesive layers were formed by applying a conductive adhesive to one side of an aluminum (Al) foil. The conductive adhesive was identical to that prepared in No. 1. A copper (Cu) foil was attached to the adhesive layers to produce an electrode-current collector. A carbon film was formed on both surfaces of the electrode current collector. After forming the carbon film, anode layers were formed on Cu foil. Further, cathode layers were formed on Al foil. Thus, a bipolar electrode was manufactured. No. 2 corresponds to a conventional bipolar electrode.

### Evaluation

FIG. 11 is a table showing evaluation results. In FIG. 11, “reference” is a value for a sample of the present experiment. In this experiment, the primary sealing property and the electrolyte resistance show the sealing property between the carbon film and the sealing material. In the items of penetration resistance, primary sealing property, and electrolyte resistance, No. 1 showed the same performance as No. 2. Therefore, it is considered that No. 1 (metal-foil-less) can withstand practical use.

What is claimed is:

1. A manufacturing method of a bipolar electrode, the manufacturing method comprising:
(a) providing a first carbon film on a support material that is in a sheet form;
(b) providing a conductive resin layer on the first carbon film;
(c) providing a second carbon film on the conductive resin layer;
(d) providing a second electrode layer on the second carbon film;
(e) separating the support material from the first carbon film; and
(f) manufacturing the bipolar electrode by providing a first electrode layer on the first carbon film, wherein the (d), the (e) and the (f) are performed in an order of the (d), the (e) and the (f).

2. The manufacturing method according to claim 1, wherein the support material includes a fluororesin.

3. The manufacturing method according to claim 1, wherein:
the first electrode layer is a cathode layer; and
the second electrode layer is an anode layer.

4. A bipolar electrode comprising:
a first electrode layer;
a first carbon film;
a conductive resin layer;
a second carbon film; and
a second electrode layer, in a thickness direction and in an order of the first electrode layer, the first carbon film, the conductive resin layer, the second carbon film, and the second electrode layer.

5. The bipolar electrode according to claim 4, wherein:
area of the conductive resin layer is larger than each of the first electrode layer, the first carbon film, the second carbon film, and the second electrode layer; and
the conductive resin layer extends to cover a side face of the first carbon film.
